(19) United States
(12) Patent Application Publication
(10) Pub. No.: US 2003/0127582 A1
(43) Pub. Date: Jul. 10, 2003

(54) Method for enhancing photomultiplier tube speed

(76) Inventor: Gareth Jones, Houston, TX (US)

Correspondence Address: DANN DORFMAN HERRELL & SKILLMAN, SUITE 720, 1601 MARKET STREET, PHILADELPHIA, PA, 19103-2307, US

(21) Appl. No.: 10/041,474

(22) Filed: Jan. 10, 2002

(51) Int. Cl. H01J 40/14

(52) U.S. Cl. 250/207

(57) ABSTRACT

In a conventional a photomultiplier tube, the present method provides for shorting the last stage or stages of dynodes to the anode, thereby causing photoelectrons therein to impact a smaller number of dynodes effectively reducing the transit time of electrons through the photomultiplier.

### BACKGROUND OF THE INVENTION

Conventional time-of-flight mass spectrometry (TOFMS) is a technique that uses electron impact (EI) ionization. EI ionization involves irradiating a gas phase molecule of the unknown composition with an electron beam, which displaces outer orbital electrons, thereby producing a net positive charge on the newly formed ion.

TOFMS has seen a resurgence due to the commercial development of two new ionization methods: electrospray ionization (ESI) and matrix-assisted laser desorption/ionization (MALDI). The availability of low cost pulsed extraction electronics, high speed digital oscilloscopes and ultra-high speed microchannel plate detectors have improved the mass resolution capability of the traditional TOFMS technique.

Mass spectrometers include three major components: (1) an ionization source; (2) a mass filter; and (3) a detector. The ionization source ionizes an unknown composition. The mass filter temporally separates the resultant ions so that lighter ions reach the detector before the heavier ions. The detector converts the ions into a charge pulse. The detector ascertains the arrival times of the charge pulses, which correspond to the masses of the ions. Identifying the masses of the ions enables identification of the unknown composition.

Typically, a TOF mass spectrometer also has a digitizer connected to the detector to process the signals.

In the MALDI technique, the analyte of interest is usually mixed in solution with a large excess of light absorbing matrix material. The sample mixture is placed on a mass spectrometer sample plate and illuminated with a pulse of light from a pulsed laser. The matrix material absorbs the laser light, the analyte molecules are desorbed from the sample surface and ionized by one of a number of ionization mechanisms.

In ESI, the analyte of interest is normally dissolved in an acidified solution. This solution is pumped out the end of a metallic capillary tube held at a high potential. This potential causes the evaporation of extremely small droplets that acquire a high positive charge. Through one of a number of mechanisms, these small droplets continue to evaporate until individual molecular ions are evaporated from the droplet surface into the gas phase. These ions then are extracted through a series of ion optics into the source region of the TOFMS.

The mass filter temporally separates ions by accelerating the ions with a bias voltage ranging up to ±30 kV. Since like charges repel, negative ions, for example, experience repulsive forces, thus tend to accelerate from, a negative potential toward a positive or less negative potential. A higher bias voltage will generate stronger repelling forces, thus greater ion acceleration. The repelling force accelerates lighter particles faster than heavier particles. Although smaller voltages foster better temporal separation, larger voltages allow for greater detection efficiency.

Detectors typically convert an ion into many electrons, forming an electron cloud which is more readily discernable. Three conventional types of detectors, or electron multipliers, generally have been used. The first type of electron multiplier is a single channel electron multiplier (SCEM). SCEMs typically are not used in modem TOFMS instruments because SCEMs provide limited dynamic range and temporal resolution, in the order of 20-30 nanoseconds to full width at half maximum (ns FWHM).

The second type of electron multiplier is a discrete dynode electron multiplier (DDEM). DDEMs exhibit good dynamic range, and are used in moderate and low resolution applications because of relatively poor pulse widths, in the order of 6-10 ns FWHM.

The third type of electron multiplier is a microchannel plate (MCP) electron multiplier. MCPs typically have limited dynamic range, in the order of 20 mHz/cm2 of active area. However, MCPs provide the highest temporal resolution, in the order of 650 ps FWHM.

Although the invention is not limited to use with an MCP-type electron multiplier, for ease of understanding, the following reviews the general operating characteristics of an MCP.

FIG. 1 shows an MCP 10. MCP 10 typically is constructed from a fused array of drawn glass tubes filled with a solid, acid-etchable core. Each tube is drawn according to conventional fiber-optic techniques to form single fibers called mono-fibers. A number of these mono-fibers then are stacked in a hexagonal array called a multi. The entire assembly is drawn again to form multi-fibers. The multi-fibers then are stacked to form a boule or billet which is fused together at high temperature. The fused billet is sliced on a wafer saw to the required bias angle, edged to size, then ground and polished to an optical finish, defining a glass wafer 15. Glass wafer 15 is chemically processed to remove the solid core material, leaving a honeycomb structure of millions of pores, also known as holes or channels, 20, which extend at an angle 25 relative to the normal flight trajectory of an ion between the surfaces 30 and 32 of MCP 10.

Referring also to FIG. 2, subsequent processing of the interior surface 35 of each channel 20 produces conductive and secondary electron emissive properties. These secondary electron emissive properties cause channel 20 to produce one or more electrons upon absorption or conversion of a particle, such as an ion, impacting surface 35. As a result, each channel 20 functions like an SCEM, having a continuous dynode source which operates relatively independently of surrounding channels 20.

Finally, a thin metal electrode 40, typically constructed from Inconel or Nichrome, is vacuum deposited on the surfaces 30 and 32 of wafer 15, electrically connecting all channels 20 in parallel. Electrodes 40 permit application of a voltage 45 across MCP 10.

MCP 10 receives ions 50 accelerated thereto by an ion-separating voltage 55. Ion 50 enters an input end 60 of channel 20 and strikes interior surface 35 at a point 62. The impact on surface 35 causes the emission of at least one secondary electron 65. Each secondary electron 65 is accelerated by the electrostatic field created by voltage 45 across channel 20 until electron 65 strikes another point (not shown) on interior surface 35. Assuming secondary electrons 65 have accumulated enough energy from the electrostatic field, each impact releases more secondary electrons 70. This process typically occurs ten to twenty times in channel 20, depending upon the design and use thereof, resulting in a significant signal gain or cascade of output electrons 80. For example, channel 20 may generate 50-500 electrons for each ion.

Gain impacts the sensitivity, or ability to detect an ion, of a spectrometer. A spectrometer with a high gain produces many electrons in an electron cloud corresponding to an ion, thus providing a larger target to detect.

Some TOF mass spectrometers drive electron clouds produced at the channel output toward an anode or charge collector, such as a Faraday cup (not shown). The charge collector sums or integrates the electron charges into a charge pulse, which is analyzed by a digitizer. Because lighter ions accelerate faster than the heavier ions, the voltage pulses correspond to the masses of the respective ions. The aggregate of arrival times of the voltage pulses corresponds to the mass spectrum of the ions. The mass spectrum of the ions aids in discerning the composition of the unknown composition.

Detecting the masses of very massive ions requires a high “post acceleration” potential between the ionization source and the MCP. A high post acceleration potential permits sufficient high mass ion conversion efficiency to enable detection of massive ions. However, MCPs cannot withstand excessive voltages thereacross without risk of significant degradation. Accordingly, some MCP-based spectrometers “float” or electronically isolate the anode from the charge collectror. To this end, the MCP output voltage is dropped to ground through a voltage divider. Unfortunately, this creates great potential for arcing or short circuiting between the output and the anode, the energy from which could damage or destroy sensitive and expensive spectrometry equipment. Thus, attaining superior temporal range with an MCP-based spectrometer which also has superior dynamic capabilities, or high sensitivity, may come at significant, unpredictable cost.

FIG. 3 shows a modular detector assembly 100 assembled with a modified vacuum flange 200 of a TOF spectrometer (not shown) described in U.S. patent application Ser. No. 09/809,090. Detector assembly 100 includes a detector cartridge 300, a scintillator 400 and a charge collector 500. Detector cartridge 300 receives the ions which enter an input end 105 from an ionization source (not shown) and produces electrons at intervals that correspond to the respective masses of the ions, as described above. Scintillator 400 receives output electrons from detector cartridge 300 and produces approximately 400 output photons for every electron absorbed. Collector 500 receives and converts the output photons into up to 5×10⁶ electrons and sums the electrons into a charge pulse. As discussed above, the timing of the pulses correspond to the masses of the ions, thereby aiding identification of an unknown composition.

Collector 500 includes a photomultiplier 505 which, responsive to the output photons of scintillator 400, generates on the order of 5×10⁶ electrons for every photon that strikes photomultiplier 505. Collector 500 also includes a socket 510 into which photomultiplier is received. Photomultiplier 505 and socket 510 are electrically connected with pins (not shown) extending from photomultiplier 505 and received in electrical contacts (not shown) in socket 510 in a known manner.

Referring to FIGS. 4 and 5, in operation, detector assembly 100 may be used to detect, for example, large negative ions. An ionization source S has multiple plates (not shown) across which a voltage repels only negative ions −i into a field free drift tube. A net +10 kV voltage exists across the gap between ionization source S and detector cartridge 300, which may contain, for example, an MCP, between ionization source output S₀, which is at ground, and MCP input voltage Pₘᵢ. Ions −i are attracted to detector cartridge 300 by the net positive voltage bias with respect to detector cartridge 300. The voltage between ionization source S and detector cartridge 300 temporally separates negative ions −i by mass. Ions −i may be post-accelerated with a high voltage to increase overall ion detection efficiency.

A net positive potential, such as +1 kV, across detector cartridge 300, i.e. between detector cartridge input (Pₘᵢ=+10 kV) and detector cartridge output (Pₘₒ=+11 kV), accelerates electrons −e, converted from ions −i, as discussed above, through detector cartridge 300. A net positive voltage, such as +2 kV, between detector cartridge 300 and scintillator 400, i.e. between detector cartridge output (Pₘₒ=+11 kV) and scintillator input (Pₛᵢ=+13 kV), accelerates electrons −e from detector cartridge 300 toward scintillator 400.

Scintillator 400 converts electrons −e into photons P. Photons P are insensitive to electrical fields, therefore the voltage across scintillator 400 may drop to ground. Photons P strike collector 500.

The photomultiplier (not shown) of collector 900 converts photons P into electrons (not shown). A net positive voltage across collector 500, such as +600 kV, from collector input (P_{co}=−600 kV) to the grounded output, urges electrons through collector 500. The electrons are summed into a charge pulse at the output C.

As shown in FIG. 5, detector assembly 100 is bi-polar in that detector assembly 100 may be operated to detect large positive ions as well as negative ions. Similar to the above, ionization source S directs only positive ions +i toward detector cartridge 300. A net −10 kV voltage between ionization source S and detector cartridge 300, i.e. between ionization source output S₀ and detector cartridge input voltage Pₘᵢ. Ions +i are attracted to detector cartridge 300 by the net negative voltage bias with respect to detector cartridge 300.

A net positive potential, such as +1 kV, across detector cartridge 300, between detector cartridge input voltage Pₘᵢ (e.g. −10 kV) and detector cartridge output voltage Pₘₒ (e.g. −9 kV), likewise accelerates electrons −e through detector cartridge 300.

Electrons −e from detector cartridge 300 travel toward scintillator 400, driven by a net positive voltage, such as +3 kV, between detector cartridge 300 and scintillator 400, i.e. between detector cartridge output (Pₘₒ=9 kV) and scintillator input (Pₛᵢ=6 kV).

Scintillator 400 converts electrons −e into photons P. The output of scintillator 400 is grounded.

Photomultiplier (not shown) in collector 500 converts photons P into electrons (not shown), which are urged therethrough with a net +600 kV voltage and summed into a charge pulse at output C.

FIG. 6 schematically shows photomultiplier 505 of FIG. 3. Photomultiplier 505 includes an evacuated envelope or vessel 515 which has a cylindrical wall 520 and a faceplate 525. A photocathode 530 is formed on an interior surface of faceplate 525 and on the interior surface of a portion of cylindrical wall 520. Light incident on faceplate 525 enters the envelope 535. Photocathode 530 converts the incident light into a plurality of first photoelectrons e₁. First photoelectrons e₁ impact a first dynode DY1. First dynode DY1 absorbs and generates for each first photoelectron e₁ a plurality of second photoelectrons e₂ which impact a second dynode DY2. Second dynode DY2 absorbs and generates for each second photoelectron e₂ a plurality of third photoelectrons e₃ which impact a third dynode DY3. Successive dynode absorption and generation by downstream dynodes DY3-DY12, similar to that described with respect to dynodes DY1 and DY2, substantially increases the gain of the energy of each photon converted by photocathode 530 into a first photoelectron e₁.

Photomultiplier 505 includes an anode A which receives photoelectrons e₁₃ generated by dynode DY12. Anode A effectively sums the charges of photoelectrons e₁₃ into a pulse. Typically, the pulse is carried from anode A to digitizing equipment for quantizing and sequencing successive pulses. Anode A is surrounded by a shield S which has the same potential as final dynode DY12 to prevent noise from developing at anode A.

As shown in FIG. 7, resistors R1-R11 are interposed among dynodes DY1-DY12 to equally divide voltage applied between terminals T₁ and T₂, between first dynode DY1 and final dynode DY12. Initial, intermediate and final terminals T₁-T₃ have voltages that establish a net positive field to urge electrons toward anode A. Thus, terminal T₁ may have a negative voltage, T₂ may be grounded and T₃ may have a positive voltage. A resistor R12 between dynode DY12 and terminal T₂ provides a potential with which to detect a signal.

An exemplary photomultiplier 505 is a Hamamatsu RU7400 photomultiplier tube, regarded as a “fast” photomultiplier. “Fast” refers to the reaction time from when a photon strikes a dynode to when a resultant electron strikes an anode of the photomultiplier. For example, the RU7400 has a reaction time of approximately 3.2 ns FWHM. Faster reaction times improve the dynamic range of a detector because the detector may identify individual ions, rather than groups of ions. Faster reaction times may be possible by connecting one or more downstream dynodes with the anode.

Although photomultiplier tubes, such as the Hamamatsu RU7400, generally are fairly fast, the photomultiplier tube stage represents the bottleneck that slows the overall responsiveness of a TOFMS. What is needed, and what is not taught or suggested by known prior art, is a method for enhancing photomultiplier tube speed by shorting out the last few stages of a photomultiplier tube.

### SUMMARY OF THE INVENTION

The invention provides a method for enhancing photomultiplier tube speed by shorting out the last few stages of a photomultiplier tube and/or employing a dynode closer than the anode to the cathode as the anode.

Accordingly, the invention is a method for enhancing the speed of a photomultiplier tube, including a plurality of discrete dynodes in multiple stages, each dynode facing an adjacent dynode within the plurality of dynodes, and an anode, involving electrically connecting a selected dynode with the anode.

The invention provides improved elements and arrangements thereof, for the purposes described, which are inexpensive, dependable and effective in accomplishing intended purposes of the invention.

Other features and advantages of the present invention will become apparent from the following description of the preferred embodiments which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a perspective view, partially in section, of a multichannel plate;

FIG. 2 is a schematic view of a single channel of the multichannel plate of FIG. 1;

FIG. 3 is a cross-sectional view of a detector assembly;

FIGS. 4 and 5 are schematic views of alternative voltages across a mass spectrometer incorporating the detector assembly of FIG. 3.

FIG. 6 is a cross-sectional view of a photomultiplier tube;

FIG. 7 is a schematic view of the electronic circuitry of the photomultiplier tube of FIG. 6; and

FIG. 8 is a schematic view of electronic circuitry for the photomultiplier tube of FIG. 6 according to the invention.

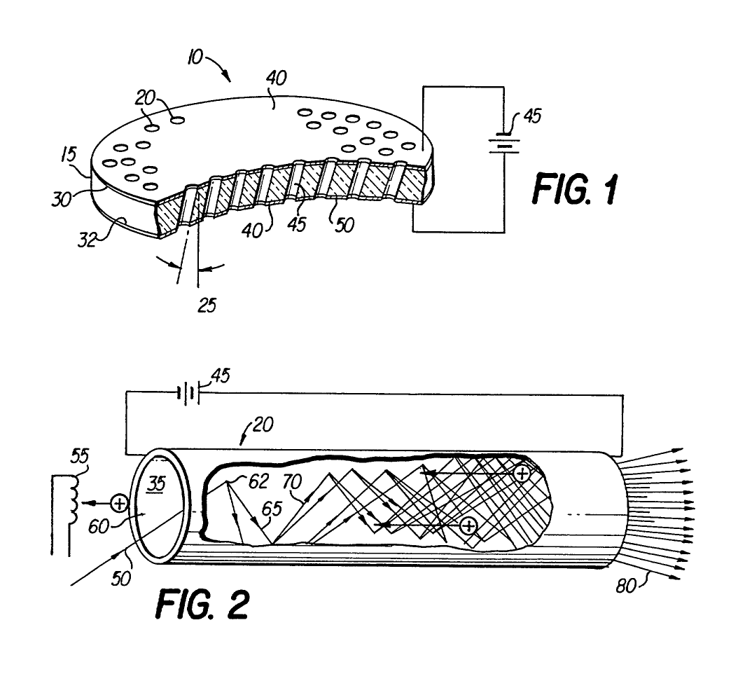

### DETAILED DESCRIPTION OF THE PREFERRED EMBODIMENTS

The invention is a method for enhancing photomultiplier tube speed by shorting out one or more final stages of a photomultiplier tube.

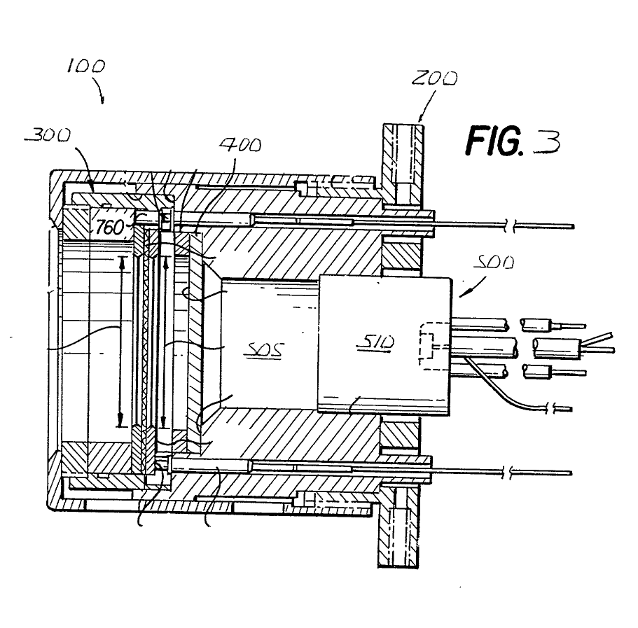

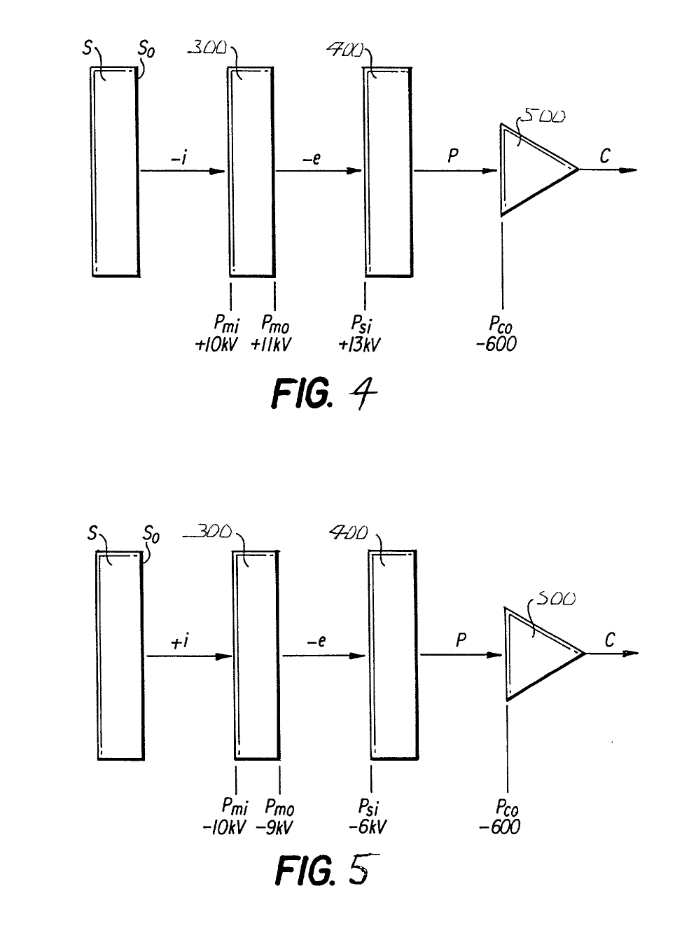

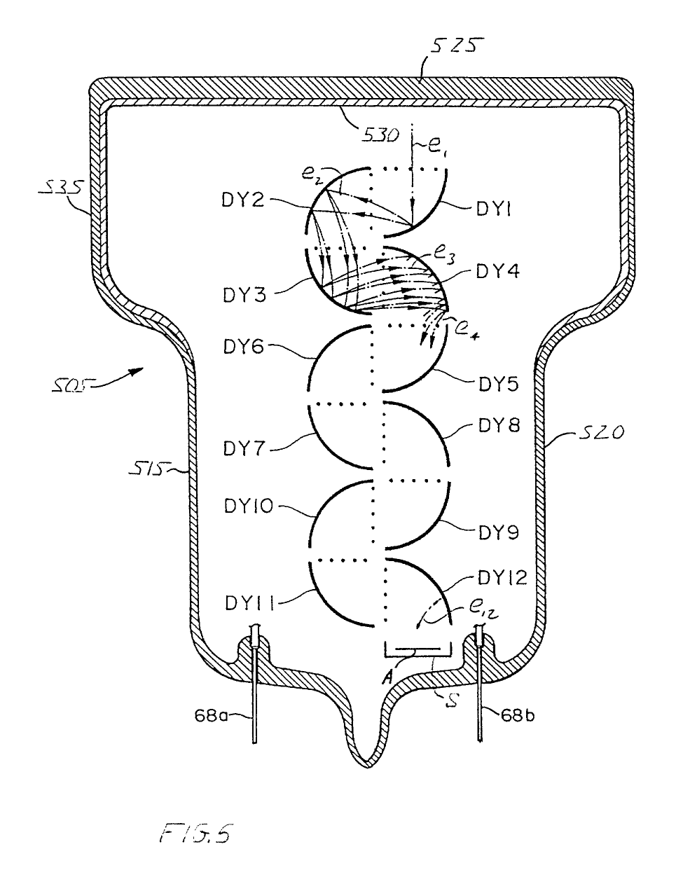

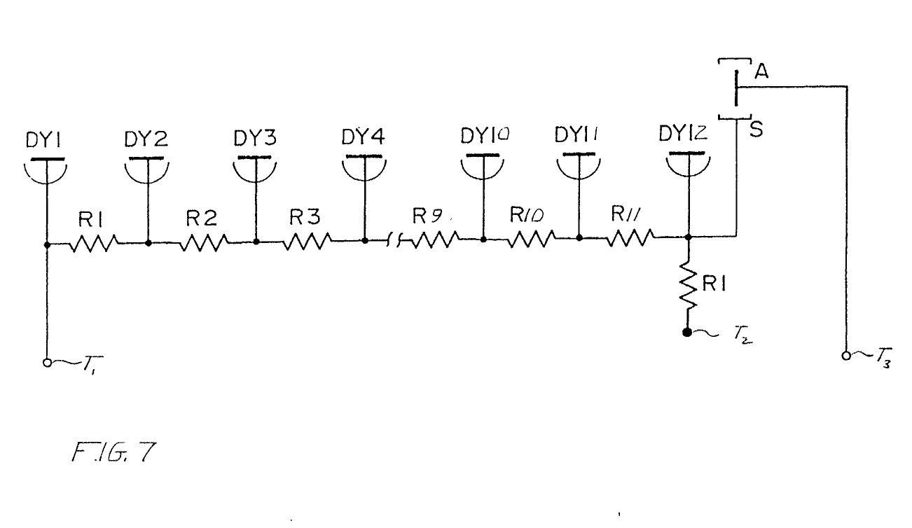

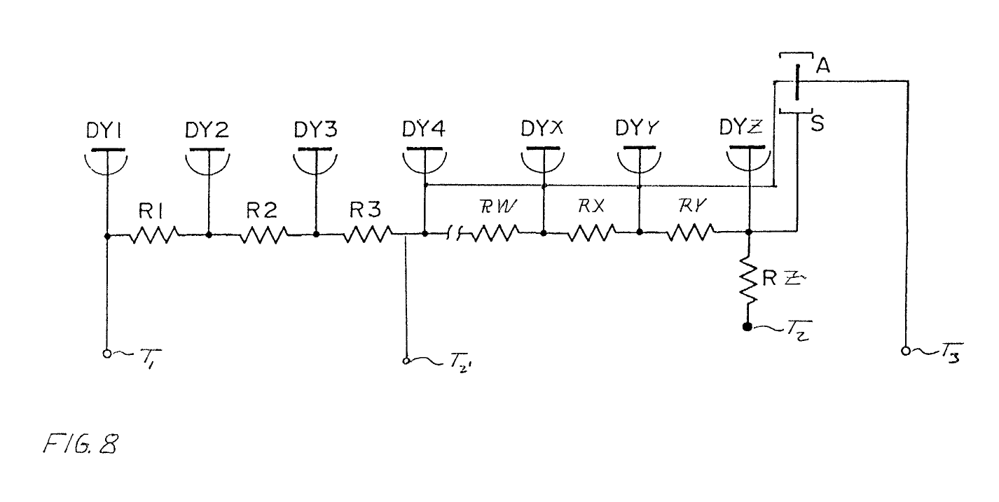

FIG. 8 shows a basic electronic circuitry schematic for a photomultiplier comparable to photomultiplier 505 of FIGS. 3 and 6, which is described above. As with photomultiplier 505, the photomultiplier with the circuitry of FIG. 8 also encounters and promotes photoelectrons that successively impact cascaded dynodes, each dynode absorbing and generating for photoelectron a plurality of resultant photoelectrons. Resistors R1-R3, RW, RX and RY are interposed among dynodes DY1-DY4, DYX, DYY and DYZ to equally divide voltage applied between terminals T₁ and T₂, between first dynode DY1 and final dynode DYZ. Initial, intermediate and final terminals T₁-T₃ have voltages that establish a net positive field to urge electrons toward anode A. Thus, terminal T₁ may have a negative voltage, T₂ may be grounded and T₃ may have a positive voltage. A resistor RZ between dynode DYZ and terminal T₂ provides a potential with which to detect a signal.

The present method provides for shorting a selected dynode, such as dynode DY4, to anode A. Thus, the photoelectrons impact a smaller number of dynodes within the associated PMT (not shown). Dynodes DYX-DYZ also are shorted to anode A to prevent unwanted charge buildup on dynodes DYX-DYZ.

The method also connects an intermediate terminal T₂, between the selected dynode (DY4) and an adjacent dynode between initial terminal T₁ and the selected dynode. As shown, resister R3 is disposed between dynode DY3 and terminal T₂, to provide a potential with which to detect a signal.

Although FIG. 8 shows dynodes DY4 and DYX-DYZ shorted to anode A, the invention is not limited to such configuration. Rather, the invention extends to all applications in which the final dynode or dynodes of a PMT are shorted to the anode thereof. Also, as with photomultiplier 505 of FIGS. 3 and 6, anode A is surrounded by a shield S which has the same potential as the final dynode, DY4 in FIG. 8, to prevent noise from developing at anode A.

Shorting the last dynode(s) to the anode effectively reduces the transit time of electrons through a photomultiplier. Such configuration may sacrifice some of the gain of the photomultiplier. However, in most applications, the gain sacrificed is not required.

The amount of transit time reduced due to the foregoing technique is difficult to calculate. First, even though dynodes DY1-DYZ all may have substantially the same geometry, be equally spaced and have equal voltages applied thereacross, transit time from the photocathode is likely to differ between stages. Second, transit time for an electron between two electrodes is a function of electric field strength therebetween, therefore a function of voltage and the shape and spacing of the electrodes, which may differ ever so slightly. Third, dynodes are not intended to serve as anodes for fast timing applications, thus may introduce inefficiencies at the collection point.

Following is a formula for calculating electron transit time. The formula is predicated on the existence of a uniform electric field between dynode stages.

$$T = {L [ \frac{2}{v ( \frac{q}{m} )} ]}^{1 / 2}$$

where q/m=1.76×10¹¹ C/kg, v=voltage and L=length.

Alternatively, the transit time may be derived from measuring peak pulse current against average pulse current to calculate pulse width. Fifty percent of the pulse width is calculated by:

Δtₛ=τ_{f}1n(2)*tₚ+τᵣ1n(I−0.5(Iₚ/Iₒ))

where τ_{f} is pulse fall time; tₚ is time to peak; τᵣ is pulse rise time; Iₚ is peak pulse current; and Iₒ is average current.

Due to the unpredictability of the reduction in electron transit time, the speed of a photomultiplier configured in accordance with the invention is not necessarily in proportion to the number of dynodes shorted out. However, the the foregoing dynode-shorting technique allows for operating a photomultiplier with a gain of less than 10×10⁴, rather than the more typically imposed gain of 10×10¹⁰.

Although the invention has been described in relation to particular embodiments thereof, many other variations and modifications and other uses will become apparent to those skilled in the art. The invention is not limited by the specific disclosure herein, but only by the appended claims.

I claim:

1. Method for enhancing the speed of a photomultiplier tube, comprising a plurality of discrete dynodes in multiple stages, each dynode facing an adjacent dynode within the plurality of dynodes, and an anode, comprising electrically connecting a selected dynode with the anode.

2. Method of claim 1, wherein the photomultiplier tube further comprises a voltage dividing circuit including a plurality of resistors connected in series between an initial terminal and an intermediate terminal for applying a suitable potential to each of the dynodes, each of the resistors being electrically connected to an adjacent resistor within the plurality of resistors;
said method further comprising connecting the intermediate terminal between the selected dynode and an adjacent dynode, the adjacent dynode being interposed between the initial terminal and the selected dynode.

3. Method of claim 1, wherein the selected dynode is selected according to an anticipated signal to be analyzed.

4. Method of claim 1, wherein the photomultiplier tube is operatively incorporated in a time of flight detector.
